(19) United States
(12) Patent Application Publication
(10) Pub. No.: US 2010/0090931 A1
(43) Pub. Date: Apr. 15, 2010

(54) DISPLAY DEVICE AND MANUFACTURING METHOD THEREOF

(76) Inventor: Kazuyoshi Kawabe, Kanagawa (JP)

Correspondence Address: EASTMAN KODAK COMPANY;PATENT LEGAL STAFF, 343 STATE STREET, ROCHESTER, NY, 14650-2201, US

(21) Appl. No.: 12/445,464

(22) PCT Filed: Oct. 10, 2007
(86) PCT No.: PCT/US07/21638

§ 371 Date: Apr. 14, 2009

(30) Foreign Application Priority Data
Oct. 24, 2006 (JP) 2006-288996
Jan. 22, 2007 (JP) 2007-011224

(51) Int. Cl. G09G 3/30; H01L 21/8234

(52) U.S. Cl. 345/76; 438/197; 257/E21.616

(57) ABSTRACT

A display device formed by arranging pixel circuits in a matrix, wherein each pixel circuit includes a self-emissive element; a drive transistor for driving the self-emissive element; and a resistor element serially connected between the self-emissive element and the drive transistor.

### CROSS-REFERENCE TO RELATED APPLICATIONS

This application claims priority of Japanese Patent Application No. 2006-288996 filed Oct. 17, 2006 and Japanese Patent Application 2007-11224 filed Jan. 22, 2007 which is incorporated herein by reference in its entirety.

### FIELD OF THE INVENTION

The present invention relates to a display device, and more particularly to an active matrix type display device including a self-emissive type electroluminescence (organic EL) element.

### BACKGROUND OF THE INVENTION

Active matrix type organic EL displays, which are self-emissive type displays, and can achieve high contrast and a wide viewing angle, as well as high resolution and high definition, have attracted attention as displays for the next generation.

In active matrix displays, an active element for storing a state is required for each pixel. In the case of organic EL displays, a drive transistor which allows continuous supply of electric current to an organic EL element is provided. Here, thin film transistors (TFTs) formed by an amorphous silicon thin film, a poly-silicon thin film, and the like are used for the drive transistors, and medium or small size organic EL displays in which poly-silicon TFTs which enable a long-time stable operation are employed have been manufactured as products.

However, characteristics of the poly-silicon TFTs differ among different pixels and therefore currents of different levels are output to the organic EL element even when an identical signal is input, resulting in disadvantages of non-uniform display and decreased yield.

Several methods for correcting the characteristics of poly-silicon TFTs by means of circuit technology have been proposed, among which a digital driving method is disclosed in WO2005116971.

With the digital driving in which a constant voltage is applied to the organic EL element, however, the organic EL element degrades with time to cause an increase in resistance thereof, which further results in a decrease in current flowing in the organic EL element. As a result, life of the element is apparently shortened.

Also, because the current flowing in the organic EL element changes depending on the surrounding temperature, it is difficult to supply stable current to the organic EL element.

### SUMMARY OF THE INVENTION

The present invention advantageously suppresses changes in current flowing in a self-emissive element such as an organic EL element.

In accordance with one aspect of the invention, there is provided a display device formed by arranging pixel circuits in a matrix, wherein each pixel circuit includes a self-emissive element, a drive transistor for driving the self-emissive element, and a resistor element serially connected between the self-emissive element and the drive transistor. The resistor element may be serially connected between the self-emissive element and an electrode, or may be serially connected between the drive transistor and the self-emissive element and between the self-emissive element and the electrode.

In the present invention, the self-emissive element is driven by a constant voltage and has only two states, that are a state in which electric current flows in the self-emissive element and a state in which no electric current flows in the self-emissive element, and brightness of the self-emissive element is controlled in accordance with a time period during which electric current flows in the self-emissive element.

Further, in accordance with another aspect of the present invention, there is provided a method of manufacturing a display device formed by arranging pixel circuits in a matrix, each pixel circuit comprising a self-emissive element, a drive transistor for driving the self-emissive element, and a resistor element serially connected between the self-emissive element and the drive transistor, wherein the resistor element is manufacturing by (a) forming a gate insulating film on a substrate, (b) forming a resist in a region on the gate insulating film where the resistor element is to be formed, (c) introducing impurities having a relatively high concentration into the gate insulating film on which the resist is formed (d) removing the resist, and (e) introducing impurities having a relatively low concentration into the gate insulating film from which the resist has been removed.

Also, in accordance with a further aspect of the present invention, there is provided a display device comprising a self-emissive element, an active matrix display array including pixel circuits arranged in a matrix, each pixel circuit being formed by a plurality of thin film transistors which control the self-emissive element, a data line provided corresponding to each column of the matrix, for supplying a data signal to a pixel circuit in a corresponding column, and a gate line provided corresponding to each row of the matrix, for supplying a selection signal to a pixel circuit in a corresponding row, wherein the pixel circuit includes a transistor for supplying electric current to the self-emissive element, and a resistor element serially connected between the transistor and the self-emissive element.

According to the present invention, changes in current flowing in a self-emissive element can be minimized with a simple structure, to thereby stabilize the operation of a display device.

### BRIEF DESCRIPTION OF THE DRAWINGS

A preferred embodiment of the present invention will be described in detail based on the following figures, wherein:

FIG. 1 is a pixel circuit diagram according to an embodiment of the present invention;

FIG. 2 is a view for explaining the IV characteristics of an organic EL element when a stabilizing resistor is employed;

FIGS. 3(A) and 3(B) show pixel layout views;

FIG. 4 is a flowchart showing processes of forming a stabilizing resistor;

FIGS. 5(A) and 5(B) are views showing an overall structure of a digitally driven organic EL display;

FIG. 6 is an explanatory view of a layered structure of the pixel circuit of the embodiment;

FIG. 7 is an explanatory view of a layered structure of a pixel circuit according to another embodiment;

FIG. 8 is an explanatory view of a layered structure of a pixel circuit according to still another embodiment;

FIG. 9 is a pixel circuit diagram corresponding to FIG. 7; and

FIG. 10 is a pixel circuit diagram corresponding to FIG. 8.

### DETAILED DESCRIPTION OF PREFERRED EMBODIMENT

A preferred embodiment of the present invention will be described in detail with reference to the accompanying drawings.

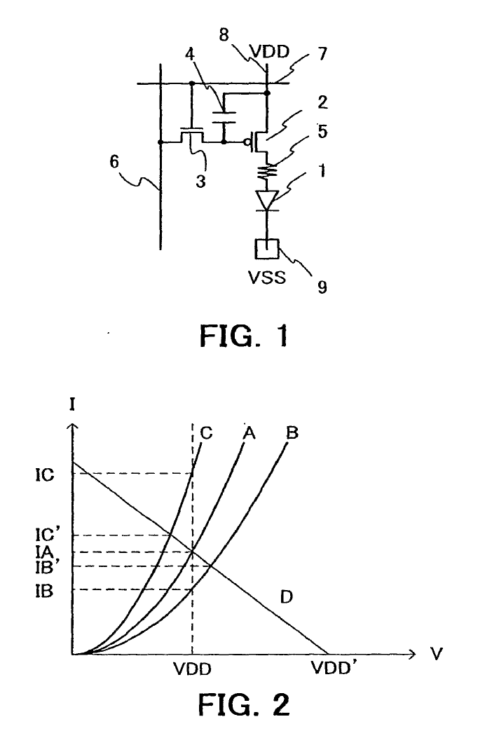

FIG. 1 shows an equivalent circuit of an organic EL display according to the present embodiment. A pixel is formed of an organic EL element 1, a drive transistor 2, a gate transistor 3, a storage capacitor 4, and a stabilizing resistor 5.

A cathode 9 of the organic EL element 1 is connected with a first power source VSS, and an anode of the organic EL element 1 is connected to one terminal of the stabilizing resistor 5. The other terminal of the stabilizing resistor 5 is connected to a drain terminal of the drive transistor 2. A source terminal of the drive transistor 2 is connected to a second power source VDD, and a gate terminal of the drive transistor 2 is connected to one terminal of the storage capacitor 4 and a source terminal of the gate transistor 3. The other terminal of the storage capacitor 4 is connected to the second power source VDD. A gate terminal of the gate transistor 3 is connected to a gate line 7 and a drain terminal of the gate transistor 3 is connected to a data line 6.

The gate transistor 3 shown in FIG. 1 is, which is an N type transistor, is energized (i.e. is turned ON) when a voltage “High” is applied to the gate line 7, whereby a signal voltage being applied on the data line 6 is written into the storage capacitor 4. When a voltage “Low” is applied to the gate line 7, on the other hand, the gate transistor 3 becomes non-energized (i.e. is turned OFF), whereby the signal voltage written in the storage capacitor 4 is stored therein until the gate transistor 3 becomes energized the next time. If the gate transistor 3 is of P type, reverse voltages with respect to those described above regarding the N type transistor are applied to the gate line 7.

When the signal voltage written in the storage capacitor 4 is sufficient for energizing the drive transistor 2, electric current flows from the second power source VDD through the drive transistor 2 to the organic EL element 1 via the stabilizing resistor 5. On the contrary, when the signal voltage written in the storage capacitor 4 is sufficient for making the drive transistor 2 non-energized, electric current does not flow in the organic EL element 1.

With digital driving, only these two states, i.e. a state in which electric current flows in the organic EL element 1 and a state in which no electric current flows in the organic EL element 1 as described above, are used to control a ratio of time period in which electric current flows in the organic EL element during one frame period, thereby controlling brightness. Thus, such a function can be sufficiently achieved by the pixel circuit shown in FIG. 1.

FIG. 2 shows how the electric current flowing in the organic EL element is stabilized by the stabilizing resistor 5 shown in FIG. 1. In FIG. 2, the horizontal axis represents voltage and the vertical axis represents current. Referring to FIG. 2, a curve A is an IV (current-voltage) curve of an organic EL element at a certain temperature T and an energizing time t. A curve B is an IV curve of the same organic EL element at the certain temperature T and an energizing time t+Δt (Δt>0) and a curve C is an IV curve of the same organic EL element at a temperature T+ΔT (ΔT>0) and the energizing time t. As shown in FIG. 2, the IV characteristics of the organic EL element generally vary depending on the temperature and the energizing time.

A straight line D shows current I flowing in the organic EL element due to a voltage V applied to the organic EL element when a resistance value of the stabilizing resistor 5 is R, and is represented by the following equation:

I=(VDD−V)/R (1)

Here, VSS=0 is assumed for the convenience of calculation. Further, in digital driving, ON resistance obtained when the drive transistor is turned ON is generally designed to have a sufficiently smaller value than that of the resistance of the organic EL element 1 so as to minimize a variation in current due to a difference in characteristics, and is therefore disregarded in the above equation (1).

With digital driving in which the stabilizing resistor 5 is not employed, the current flowing in the organic EL element 1 at the reference temperature T and the reference time t is IA, from the IV curve A. This current value, however, decreases significantly to the current value IB due to degradation of the organic EL element, and also increases significantly to the current value IC with rise in temperature. In the former case, due to deterioration of current caused by energization, so-called “image persistence” in which brightness is lowered even when an identical video signal is supplied, is caused. In the latter case, the power consumption increases even when an identical video signal is applied, which accelerates degradation of the organic EL element.

On the other hand, when the stabilizing resistor 5 is connected serially between the drive transistor 2 and the organic EL element 1 as in the present embodiment, the current flowing in the organic EL element 1 is determined by intersections of the IV curves A, B and C, respectively, with respect to the straight line D. As such, the current flowing in the organic EL element 1 changes along the straight line D, so that the changes in the current caused by the temperature and the energization time can be suppressed. More specifically, the current deterioration with the degradation of the organic EL element can be suppressed to the current IB′ and the current increase due to the temperature rise can also be suppressed to the level IC′. Specifically, with the stabilizing resistor 5, the current change from IA to IB can be suppressed to the change from IA to IB′, and also the current change from IA to IC can be suppressed to the change from IA to IC′.

Here, the resistance value R is a reciprocal of the inclination of the straight line D as shown by the equation (1), and therefore, as the resistance value R is greater, the inclination of the straight line is smaller and therefore stabilized. In this case, however, as voltage drop increases under the stabilized resistance, the power consumption is increased. It is therefore desired to set an appropriate current value in consideration of the stability of the organic EL element.

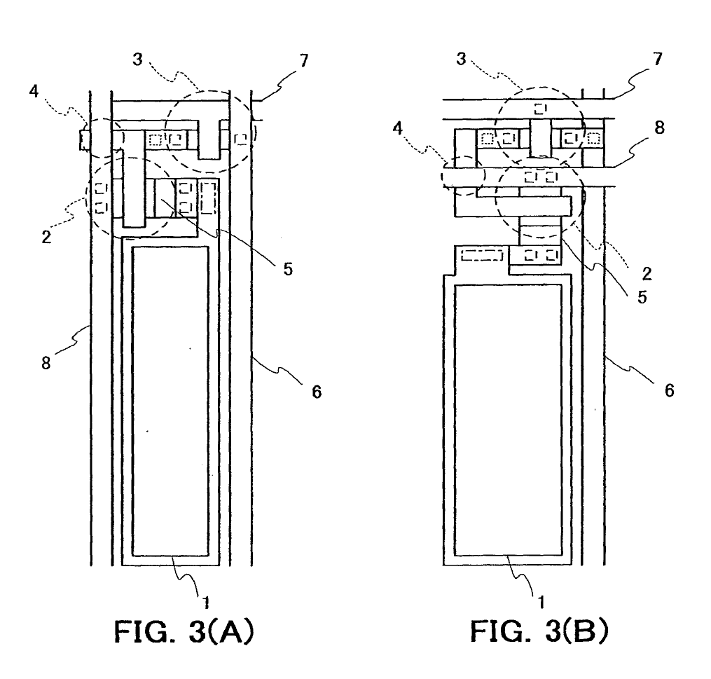

FIG. 3 shows pixel layouts each including an equivalent circuit shown in FIG. 1 formed on a glass substrate. The pixel layout shown in FIG. 3(A) is an example in which a first metal is applied to the gate line 7 disposed in the horizontal direction and a second metal is applied to the data line 6 and a power source line 8 disposed in the vertical direction. The pixel layout shown in FIG. 3(B) is an example in which the second metal is applied to the gate line 7 and the power source line disposed in the horizontal direction and the first metal is applied to the data line 6 disposed in the vertical direction.

In the low temperature poly-silicon process, a resistor element is normally formed in a manufacturing step of forming a poly-silicon film into N or P type, which is performed at the time of forming source and drain electrodes of a transistor. The resistor element thus formed has a sheet resistance value of approximately several kΩ to several tens of kΩ. Accordingly, if the resistance value of several MΩ is required for the stabilizing resistor 5 in order to stabilize the changes in current, it is necessary to form the stabilizing resistor 5 in an elongated shape in the current flowing direction. However, it is not practical to form such an elongated stabilizing resistor 5 because the stabilizing resistor 5 needs to have a length which is several hundred to several thousand times longer than the width thereof when calculated from the sheet resistance value described above, and therefore consumes a large area. In such a case, it is preferable to introduce a manufacturing step of forming the stabilizing resistor 5 separately from the step of forming the source and drain of the transistor.

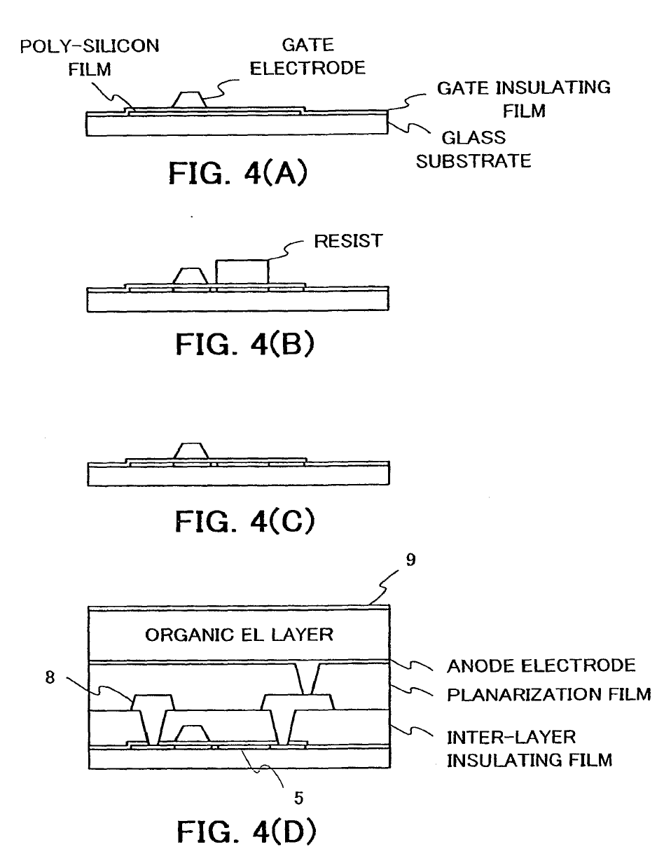

FIG. 4 shows example steps of forming the stabilizing resistor 5, with the drive transistor 2 being shown in cross section. After a poly-silicon film is formed on a glass substrate, a gate insulating film is formed, and a gate electrode of the transistor is further formed of a first metal on the gate insulating film (FIG. 4(A)). Then, a resist is formed in a region where the stabilizing resistor 5 is to be formed. Highly concentrated P type impurities are introduced into the poly-silicon film at portions which are not masked with the gate electrode and the resist, thereby forming heavy P-type source and drain electrodes of the transistor (FIG. 4(B). The resist is then removed, and low concentration P type impurities are introduced into the poly-silicon film, so that the impurities are introduced into portions of the poly-silicon film not masked with the gate electrode. Consequently, the stabilizing resistor forming region on which the resist was formed is changed into a light P-type (P-) region (FIG. 4(C)). After completion of introduction of the impurities, the transistor is covered with an inter-layer insulating film, and lines for the source and drain regions are formed from a second metal. Then, a planarization film and an anode electrode are formed, and an organic EL layer is further formed, so that a pixel shown in FIG. 3 is manufactured (see FIG. 4(D)).

As such, due to addition of the low concentration impurities introduction step, sheet resistance can be increased. Consequently, even when a large resistance value is required as described above, the need to occupy a large stabilizing resistor region can be eliminated. In other words, even when the stabilizing resistor 5 is introduced within a pixel, this has substantially no effect on the region where the organic EL element 1 is to be formed. Further, it is also possible to appropriately adjust the concentration of impurities to thereby change the resistance value in accordance with the IV characteristics of the organic EL element 1.

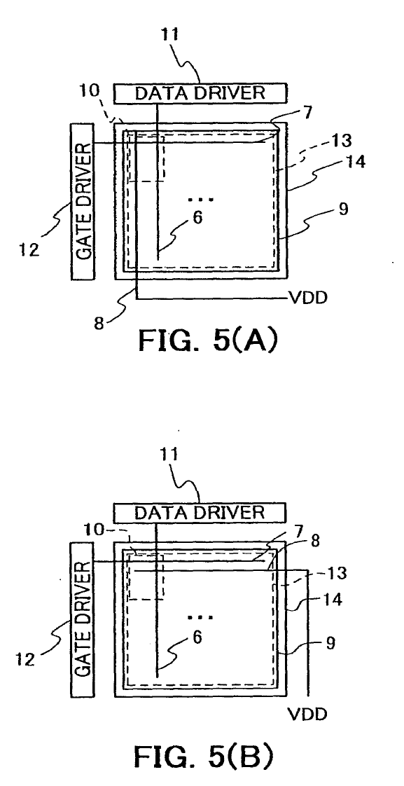

FIG. 5 shows an organic EL panel 14 having an active matrix type display array 13 including the pixel circuits 10 shown in FIG. 1 arranged in a matrix shape, in which a data driver 11 is connected to the end portions of the respective data lines 6 and a gate driver 12 is connected to the end portions of the respective gate lines 7. When the pixel layout shown in FIG. 3(A) is adopted, the structure shown in FIG. 5(A), in which the power source line 8 is arranged in the vertical direction as a common line, is formed. Further, when the pixel layout shown in FIG. 3(B) is adopted, the structure shown in FIG. 5(B), in which the power source line 8 is arranged in the horizontal direction, is formed. A cathode 9 is common with respect to all the pixels and is connected with the first power source VDD.

The gate driver 12 supplies a selection voltage which causes the gate transistor 3 to turn ON or OFF to the gate lines 7 sequentially starting from the first line. At this time, the data driver 11 supplies a signal voltage which causes the drive transistor 2 to turn ON or OFF to the data line 6, thereby writing the signal voltage to the corresponding storage capacitor 4. Thus, emission or non-emission of light by the organic EL element is controlled. This operation is repeated for each sub-frame, thereby achieving digital driving.

Here, the data driver 11 and the gate driver 12 may be formed in the low-temperature poly-silicon forming process on the glass substrate on which the pixels are formed.

As described above, by forming an organic EL panel in which the stabilizing resistor 5 is introduced in a pixel, deterioration of current resulting from the increased resistance due to degradation of the organic EL element with time and changes in current resulting from the temperature changes can be stabilized even when digital driving in which a constant voltage is applied is used. Consequently, an organic EL display with enhanced reliability can be obtained.

While the resistance value of the stabilizing resistor 5 in the present embodiment can be set as desired, it can be set to a range between 0.5 MΩ and 10 MΩ. Further, it is desirable to set the resistance value such that the current changes fall within a range of ±5% with the temperature changes of the organic EL element from 0° C. to 6° C. In addition, it is desirable to set the resistance value such that a decrease in current caused by degradation of the organic EL element after elapse of 1000 hours falls within a range of ±5%.

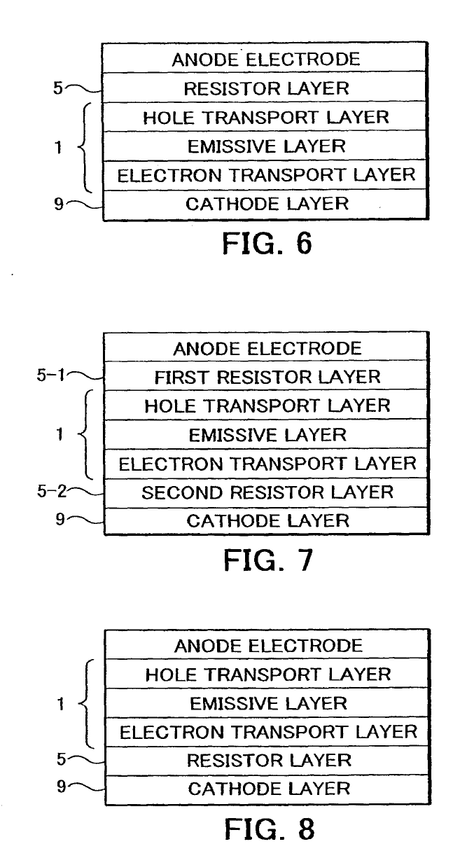

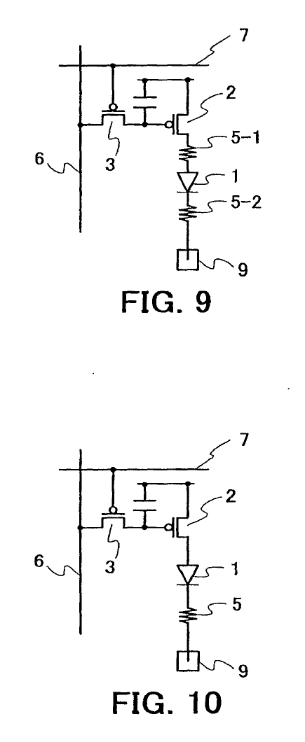

In the above example, the stabilizing resistor 5 is serially connected between the organic EL element 1 and the drive transistor 2 as shown in FIG. 1, and a layered structure of the cathode 9/the organic EL element 1 (including an electron transport layer/an emissive layer/a hole transport layer)/the resistor layer 5/the anode electrode sequentially formed, in this order from the substrate side, is provided as shown in FIG. 6. Alternatively, a second stabilizing resistor may further be formed between the cathode 9 and the organic EL element 1. Specifically, as shown in FIG. 7, the first resistor layer 5-1 is formed between the organic EL element 1 and the anode electrode (disposed on the drive transistor side) and the second resistor layer 5-2 is further formed between the organic EL element 1 and the cathode 9. Further, the resistor layer 5 may be formed only between the cathode 9 and the organic EL element 1, as shown in FIG. 8. FIG. 9 shows an equivalent pixel circuit corresponding to the layered structure shown in FIG. 7, and FIG. 10 shows an equivalent pixel circuit corresponding to the layered structure shown in FIG. 8. In FIG. 9, the stabilizing resistor 5-1 is serially connected between the drive transistor 2 and the organic EL element 1 and the stabilizing resistor 5-2 is serially connected between the organic EL element 1 and the cathode 9. Further, in FIG. 10, the resistor 5 is serially connected between the organic EL element 1 and the cathode 9. It is desirable that, in all the stabilizing resistors 5-1 and 5-2 shown in FIG. 9 and the stabilizing resistor 5 shown in FIG. 10, changes in the resistance value is small and the resistance value is set close to the impedance of the organic EL element 1, that is, a value between several hundreds kΩ and several MΩ. Further, as can be recognized from the layered structures shown in FIG. 6 to FIG. 8, it is desirable that absorption of visible light generated by the organic EL element 1 is small in each resistor layer. In other words, it is desirable that each resistor layer be transparent to visible light.

While the preferred embodiment of the present invention has been described using specific terms, such description is for illustrative purposes only, and it is to be understood that changes and variations may be made without departing from the spirit or scope of the appended claims.

### PARTS LIST

1 organic EL element
2 drive transistor
3 gate transistor
4 storage capacitor
5 stabilizing resistor
6 data line
7 gate line
8 power source line
9 cathode
10 pixel circuits
11 data driver
12 gate driver
13 display array

1. A display device formed by arranging pixel circuits in a matrix, wherein each pixel circuit comprises:
a self-emissive element;
a drive transistor for driving the self-emissive element; and
a resistor element serially connected between the self-emissive element and the drive transistor.

2. A display device formed by arranging pixel circuits in a matrix, wherein each pixel circuit comprises:
a self-emissive element;
a drive transistor for driving the self-emissive element; and
a resistor element serially connected between the self-emissive element and an electrode.

3. A display device according to claim 1, wherein:
the self-emissive element is driven by a constant voltage and has only two states that are a state in which electric current flows in the self-emissive element and a state in which no electric current flows in the self-emissive element, and brightness of the self-emissive element is controlled in accordance with a time period in which electric current flows in the self-emissive element.

4. A method of making a resister a display device formed by arranging pixel circuits in a matrix, each pixel circuit including a self-emissive element a drive transistor for driving the self-emissive element; and a resistor element serially connected between the self-emissive element and the drive transistor:
wherein the method comprises:
forming a gate insulating film on a substrate;
forming a resist in a region on the gate insulating film where the resistor element is to be formed;
introducing impurities having a relatively high concentration into the gate insulating film on which the resist is formed;
removing the resist; and
introducing impurities having a relatively low concentration into the gate insulating film from which the resist has been removed.

5. A display device comprising:
a self-emissive element;
an active matrix display array including pixel circuits arranged in a matrix, each pixel circuit being formed by a plurality of thin film transistors which control the self-emissive element;
a data line provided corresponding to each column of the matrix, for supplying a data signal to a pixel circuit in a corresponding column; and
a gate line provided corresponding to each row of the matrix, for supplying a selection signal to a pixel circuit in a corresponding row,
wherein the pixel circuit includes:
a transistor for supplying electric current to the self-emissive element; and
a resistor element serially connected between the transistor and the self-emissive element.

6. A display device according to claim 1, wherein:
a sheet resistance value of the resistor element differs from sheet resistance values of a source and a drain of the transistor.
